(19) United States
(12) Patent Application Publication
(10) Pub. No.: US 2010/0106415 A1
(43) Pub. Date: Apr. 29, 2010

(54) SYSTEM AND METHOD FOR ANALYZING A ROUTE LOCATION

(75) Inventors: Stephen J. Pierz, Peoria, IL (US); Leslie J. Paulson, Peoria, IL (US)

Correspondence Address: Caterpillar Inc.;Intellectual Property Dept., AH 9510, 100 N.E. Adams Street, PEORIA, IL, 61629-9510, US

(73) Assignee: CATERPILLAR INC., Peoria, IL (US)

(21) Appl. No.: 12/259,349

(22) Filed: Oct. 28, 2008

(51) Int. Cl. G01C 21/20; G06F 19/00; G06Q 10/00

(52) U.S. Cl. 701/213; 701/207; 705/8

(57) ABSTRACT

A system and method for analyzing a route location is provided. The system has a position determining system for identifying a route location, a data measurement system on a machine for obtaining a route parameter at the route location at a first time and a route parameter at the route location at a second time; a data storage system for storing the route parameters; and a comparator for detecting a change in the route parameters over time.

### TECHNICAL FIELD

This disclosure relates generally to a system for analyzing a route location. In particular, the disclosure relates to a system for gathering and storing data about a route location for comparison over a time interval.

### BACKGROUND

Various transportation routes, such as highways, railways, footpaths, and other roads, change over time. For example, the surface of a highway may deteriorate due to traffic, erosion, or other forces. It is desirable to monitor these conditions in order to ensure an efficiently functioning route. In addition, monitoring these conditions over time may help predict when a work task such as preventative maintenance is needed on the route.

Various methods exist to monitor the conditions at a particular route location. For example, a surveyor may travel to a specific route location and take measurements of the route at different times. This also may be done in connection with other work being performed on the route.

However, the above-mentioned methods have drawbacks. First, these methods may require diverting traffic along the route during completion of data measurement. Second, these methods do not allow for easy or automated comparisons of route conditions at the same route location over different times.

The present disclosure is directed to overcoming or mitigating one or more of the problems set forth above.

### SUMMARY OF THE INVENTION

In one embodiment of the disclosure, a system for analyzing a route location is disclosed. The system includes a position determining system for identifying the route location, and a data measurement system on a machine for obtaining a route parameter at the route location at a first time and a route parameter at the route location at a second time. The system also includes a data storage system for storing the route parameters, and a comparator for detecting a change in the route parameters over time.

In another embodiment of the disclosure, a method of analyzing a route location is disclosed. The method includes identifying a route location and obtaining a first set of route parameter data at the route location from a machine traversing the route at a first time. The method also includes recording the first set of route parameter data to a computer-readable storage medium. The method further includes obtaining a second set of route parameter data at the route location from a machine traversing the route at a second time, and recording the second set of route parameter data to a computer-readable storage medium. The method also includes comparing the first and second sets of route parameter data.

### BRIEF DESCRIPTION OF THE DRAWINGS

FIG. 1 is a schematic illustration of a system in accordance with an embodiment of the present disclosure.

FIG. 2 is a flow chart of a method for analyzing a route in accordance with an embodiment of the present disclosure.

### DETAILED DESCRIPTION

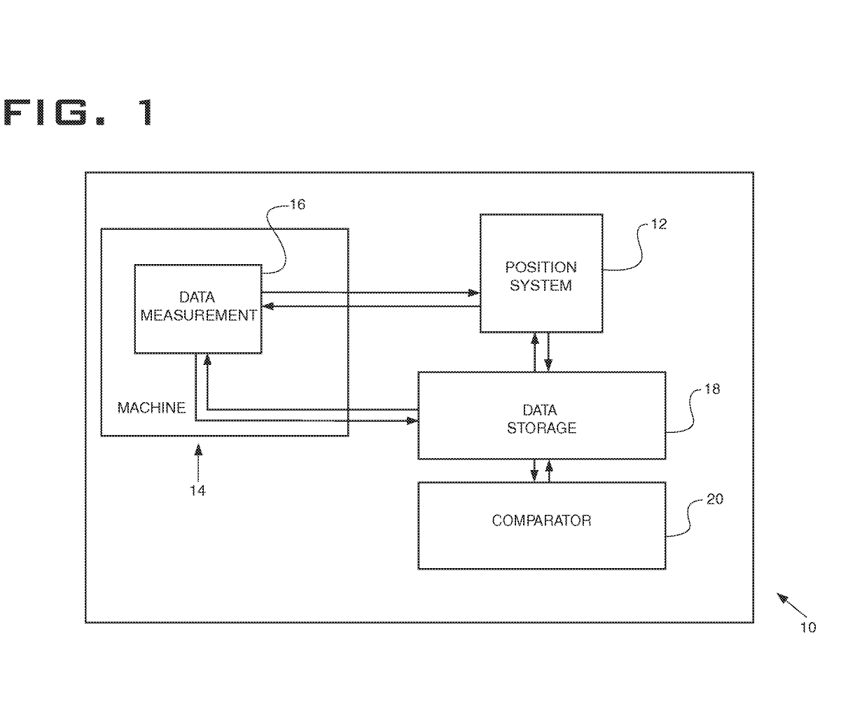

FIG. 1 shows an exemplary system 10 for analyzing a route location. The term “route” as used herein includes various types of routes, such as highways, railways, roads, sidewalks, trails, footpaths, and racetracks. The composition of the surface forming the route may vary. For example, the route may be composed of asphalt, concrete, brick, gravel, dirt, or any other surface or combination of surfaces. The route may also contain water or snow. In addition, the term “route location” includes a specific point or a delineated area of the route that represents a subsection of the total route.

System 10 includes a position determining system 12. The position determining system 12 locates the position of machine 14 and/or the location of specific data measurement tools on machine 14. Position determining system 12 may be physically separate from machine 14, or be partially or wholly contained on machine 14. Position determining system 12 may include a global positioning system (GPS), a laser-guided system, a proximity detection system using methods such as radio-frequency identification (RFID), or another position determining system commonly known in the art. Position determining system 12 may also be a combination of the above systems that determine at least one coordinate or parameter used in determining the position of machine 14.

Machine 14 may be one of a variety of different machines. Machine 14 may be a passenger vehicle, or a truck, excavator, loader, motor grader, compactor, or like machine. Machine 14 may be capable of traversing the route itself, or an area near the route (such as alongside the route itself). For railways, machine 14 may include a locomotive, railcar, or other device designed to traverse a railway or an area near a railway. The machine need not have a human operator on the machine. For example, machine 14 may be an autonomous or semi-autonomous machine for use in certain mining environments, or environments having extreme climates.

Machine 14 is equipped with a data measurement system 16. Data measurement system 16 includes one or more devices used to obtain a route parameter at a route location. As used herein, a “route parameter” includes data relating to the route location. Examples of route parameters include: a photographic image, an ultrasonic image, an infrared image, a spectrogram or other spectroscopic data, a radar image, one or more values measuring the smoothness of a subsection of the route. A route parameter also includes data about the subsurface of the route location, which may help to detect conditions at the route location which are not readily visible.

As shown in FIG. 1, system 10 further includes a data storage system 18. Data storage system 18 may include one or more computer databases to store data received from position determining system 12 and data measurement system 16. In FIG. 1, data storage system 18 is physically separate from machine 14. However, data measurement system 16 may be located partially or wholly on machine 14 and integrated with the other on-board systems of machine 14. In other words, data storage system 18 need not be dedicated entirely to system 10, and may be a shared resource devoted to other functions besides the route analysis performed by system 10.

Data storage system 18 is configured to store route parameters obtained at different times from one or more route locations. For example, data storage system 18 may store a photographic image of a particular route location taken a first time, and store a photographic image of the same route location taken at a second time.

Data storage system 18, data measurement system 16, and position determining system 12 may be interconnected through a variety of communications protocols well known in the art. For example, these systems may be connected by means of common networking protocols using wired or wireless communications protocols.

In FIG. 1, data storage system 18 is operably connected to comparator 20. Comparator 20 may be a software program or algorithm for detecting a change in one or more route parameters at a route location over time. Comparator 20 may calculate a change, such as determining a numerical difference in smoothness values for the same route location over time. Alternatively, comparator 20 may not perform an actual calculation, but instead may reproduce the route parameters in such as fashion so as to allow a human user to make comparisons that are not easily amenable to detection via a computation. For example, comparator 20 may allow for easy display of photographic images of the same route location over time, allowing a user to visually detect whether there are any notable changes in conditions at the route location over time. In this configuration, the system would optionally include a data display system (such as a display screen) for displaying information corresponding to at least one route parameter.

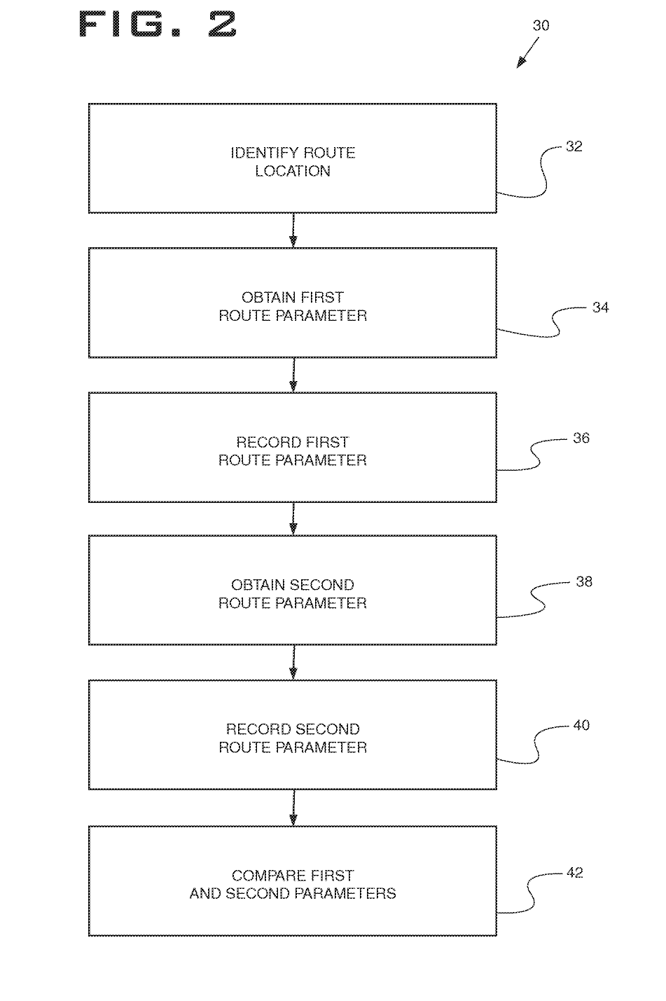

FIG. 2 shows a method 30 for analyzing a route. Method 30 may include identifying a route location, step 32. This step may be performed manually by a human operator or automatically as a machine traverses the route.

Method 30 may also include the step of obtaining a first set of route parameter data at the route location from a machine traversing the route at a first time, step 34. Route parameter data includes the route parameters discussed above with respect to FIG. 1.

Method 30 may further include the step of recording the first set of route parameter data to a computer-readable storage medium, step 36. This may occur on a machine traversing the route, or may be communicated for storage at a remote location, such as at a base station or other central location.

Method 30 may include the additional step of obtaining a second set of route parameter data at the route location from a machine traversing the route at a second time, step 38. The route location in step 38 is the same as the route location in step 34, although minor deviations can be tolerated. For example, a second photographic image of substantially the same route location as a first photographic image may be acceptable, even if the two images do not depict precisely the same location in entire image frame.

Method 30 may also include the step of recording the second set of route parameter data to a computer-readable storage medium, step 40. As in step 36, this may occur on a machine traversing the route, or may be communicated for storage at a remote location, such as at a base station or other central location. The same medium need not necessarily be used for step 40 as step 36.

Method 30 may include the step of comparing the first and second sets of route parameter data, step 42. As discussed with respect to the system of FIG. 1, the comparing step may include computations to detect if there are changes in the route location over time, or presenting the data for an operator to make such a comparison. This comparison may aid in determining whether a work task is required at the route location, such as maintenance, repair, or further testing. Other work tasks which may be scheduled in response to the comparison include adding or removing material at the route location, or altering the smoothness characteristic of the route location.

### INDUSTRIAL APPLICABILITY

The present disclosure provides an advantageous system and method for analyzing a route location. The disclosure may help determine the condition of a route, and aid in efficiently forecasting, scheduling and performing maintenance on the route. For example, the disclosed system and method may be used to monitor conditions of a road at a mining site in order to forecast when maintenance is required on a road. In addition, the disclosed system and method may be used on a highway to measure the performance of the road surface over time to ensure that the wear characteristics of the surface are in accordance with design expectations.

Other embodiments, features, aspects, and principles of the disclosed examples will be apparent to those skilled in the art and may be implemented in various environments and systems.

What is claimed is:

1. A system for analyzing a route location, comprising:
a position determining system for identifying the route location;
a data measurement system on a machine for obtaining a route parameter at the route location at a first time and a route parameter at the route location at a second time;
a data storage system for storing the route parameters; and
a comparator for detecting a change in the route parameters over time.

2. The system of claim 1, including a data display system for displaying information corresponding to at least one route parameter.

3. The system of claim 1, wherein the position determining system is a global positioning system.

4. The system of claim 1, wherein the position determining system is a laser-guided system.

5. The system of claim 1, wherein the route parameter includes a photographic image.

6. The system of claim 1, wherein the route parameter includes an ultrasonic image.

7. The system of claim 1, wherein the route parameter includes an infrared image.

8. The system of claim 1, wherein the route parameter includes spectroscopic data.

9. The system of claim 1, wherein the route parameter includes subsurface information.

10. A method of analyzing a route location, comprising the steps of:
identifying a route location;
obtaining a first set of route parameter data at the route location from a machine traversing the route at a first time;
recording the first set of route parameter data to a computer-readable storage medium;
obtaining a second set of route parameter data at the route location from a machine traversing the route at a second time; and
recording the second set of route parameter data to a computer-readable storage medium; and
comparing the first and second sets of route parameter data.

11. The method of claim 1O, further comprising the step of displaying information corresponding to the first set of route parameter data and the second set of route parameter data.

12. The method of claim 10, further comprising the step of sending a machine to the route location in response to the comparison of the first and second sets of route parameter data.

13. The method of claim 10, further comprising the step of scheduling a work task at the route location in response to the comparison of the first and second sets of route parameter data.

14. The method of claim 13, wherein the work task includes removing material from the route location.

15. The method of claim 13, wherein the work task includes changing a smoothness characteristic of the route location.

16. The method of claim 13, wherein the work task includes moving water or snow at the route location.
